(19) United States
(12) Patent Application Publication
(10) Pub. No.: US 2018/0339260 A1
(43) Pub. Date: Nov. 29, 2018

(54) Hydrogen Gas Cartridge Filter Using Graphene Film

(71) Applicant: Michael Eugene Thomas, Pocomoke City, MD (US)

(72) Inventor: Michael Eugene Thomas, Pocomoke City, MD (US)

(21) Appl. No.: 15/487,085

(22) Filed: May 23, 2017

(51) Int. Cl. B01D 53/04

(52) U.S. Cl. CPC B01D 53/04; B01D 2257/108; B01D 2253/102

(57) ABSTRACT

A gas feedstock input is provided to accurately supply a hydrogen source from an input gas feedstock supply. The gas input feedstock will be used for the selective absorption graphene cartridge filter process for the production of 99.9% purity hydrogen gas. The gas feedstock filtration science has shown increases in the concentration of hydrogen at the graphene filter output and that this certified hydrogen production can be used in today's fuel cell technologies, transportation, power plants, and space propulsion technologies, as well as, other technologies. The proposed invention expects the unique hydrogen gas graphene cartridge filter device to be used with any gas input feedstock that contains hydrogen to deliver the purest hydrogen gas of atomic size 1 to 2 Angstroms.

CROSS-REFERENCES TO RELATED APPLICATION

| | | |
|---|---|---|
| 7,883,627 | February 2011 | Barrett |
| 6,444,016 | September 2002 | Oshima |
| 5,686,056 | November 1997 | Kimtantas |
| 9,476,133 | October 2016 | Gilman |
| 9,416,457 | August 2016 | McAlister |
| 8,764,966 | July 2014 | Vajo |

### BACKGROUND OF THE INVENTION

The invention has a unique, innovative, proprietary solution to this problem by filtering and separating hydrogen gas from all other gases using graphene selective absorption method. The invention proposes the world's first hydrogen gas filter for numerous applications of scientifically engineered hydrogen gas for a viable solution in sustainable, nearly emissions-free energy. To this end, the present invention is a unique selective absorption filter technology that will produce 99.9% free hydrogen gas in the atomic size of 1.42 angstroms to 2 angstroms. The filtering of monatomic hydrogen (₁H) and molecular hydrogen (H₂) from a gas input source containing ₁H or H₂ produced at the location where the hydrogen gas will be needed. The small size and portability will allow from many energy applications worldwide. The patent application will be pioneering filtered monatomic hydrogen (protons—₁H) and molecular (H₂) that can be used by fuel cell automobiles, trucks, planes, trains, ships, medical instruments, scientific investigation, chemical manufacturing and power plants. Expectations are to make continuing discoveries in hydrogen gas filter extraction science that can work towards solving better hydrogen chemistry allowing for improved conditions of many materials, metals, medicines, drugs, and renewable energy as some of the goals.

The benefit of this unique nanotechnology to the world is, stable high purity 99.9% hydrogen. The world's first known scientifically engineered inexpensive, small, portable, stand-alone hydrogen filtration device using graphene sheets as a filtration material. Proof of concept with 2 years of operation certification-of-concept yields success, the invention envisions a time when scientifically engineered hydrogen will help increase higher quality energy generation and controlling hydrogen purity. Our scientific technology is focused on actual low cost site filtration of hydrogen gas that can compete with other future worldwide energy sources in the market place, which will lead to tangible, disruptive, and cleaner renewable hydrogen energy products.

### OBJECT OF THE INVENTION

It is the object of the present invention to provide unique improvements in all of the above-mentioned areas and to produce a hydrogen gas using a graphene filter from a gas feedstock that uniquely out performs all known hydrogen cartridge filter production technologies in the state of the art as it now exists.

### BRIEF SUMMARY OF THE INVENTION

The invention is a “transformational technology” unique patent application filtration process that will allow us to produce monatomic hydrogen (1H) and molecular hydrogen (H2) inexpensively, efficiently, and in continuous volumes from a gas feed stock. Our technology will create a conduit for a new energy paradigm held by and controlled by an independent American research and development company.

### BRIEF DESCRIPTION OF THE SEVERAL VIEWS OF THE DRAWING

The accompanying drawings, which are incorporated in and form a part of the specification, illustrate the embodiment of the invention and, together with the description, serve to explain the principles of the invention. In the drawings:

FIG. 1 is an overall block diagram of an exemplary filter extraction of hydrogen using a graphene filter and a gas feedstock for the production of high purity hydrogen in accordance with the present invention;

### DETAILED DESCRIPTION OF THE INVENTION

Although only a few presently preferred exemplary embodiments have been discussed in detail above, those of ordinary skill in the art will certainly realize that many modifications are possible without departing from the scope and spirit of the present invention as defined in the following.

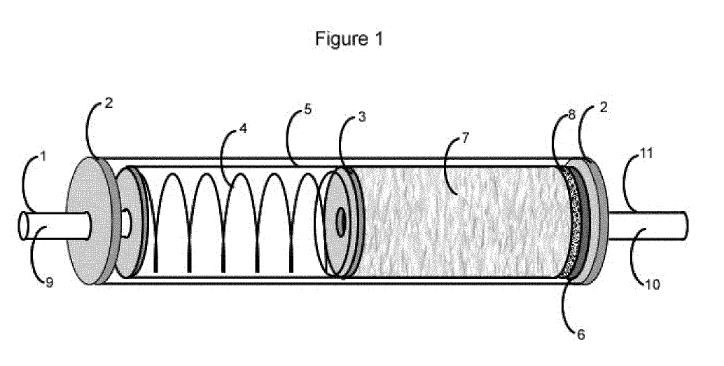

FIG. 1 is an overall block diagram of a presently preferred exemplary embodiment of a graphene selective absorption filter for the production of hydrogen gas schematic process using a gas feedstock containing hydrogen gas and to recover the suspended hydrogen gas in the feedstock in accordance with the present invention. Referring to FIG. 1, includes overall schematic of a hydrogen gas filter using graphene film material extraction filter housing 2, a clean gas input feedstock containing CO₂, O₂, N, H₂ and other gases 9, a clean extracted hydrogen gas output 10, gas feedstock input holding chamber 5, graphene material sheets for hydrogen gas filter chamber 7, extracted hydrogen gas output port 11, gas feedstock input port 1, micro screen 8, support washers 6 and 3, and constant pressure spring 4 in the process FIG. 1.

When gas feedstock 9 is pumped or vacuumed in thru port 1 it enters the input feedstock chamber 5. The gas feedstock enters the graphene filter chamber 7 where only hydrogen gas of the size 1.4 to 2 angstroms is allowed to pass thru the micro screen 8 to output port 11.

The hydrogen graphene selective absorption filter production processes of FIG. 1 will provide a 99.99% pure hydrogen source for further applications usage.

1. What I claim as my invention is graphene filtration by selective absorption method of hydrogen gas from a gas feedstock and the hydrogen production, filtration, and removal by:
a graphene material used as a hydrogen gas cartridge filter for extracting hydrogen gas from the gas feedstock,
a method for separating and collecting the hydrogen gas from the feedstock by the use of graphene materials,
a method for filtration of hydrogen gas from a gas input feedstock,
a self-contained, sealed, transportable, autonomous cartridge for input of gas feedstock, hydrogen gas graphene filtration, outputting the filtered hydrogen, and
an atomic species of hydrogen gas for energy use to a receiving fuel cell or other custom power conversion technology.

2. The hydrogen gas graphene filter process of claim 1, wherein said hydrogen gas containing absorbed CO₂ gas or other gases as the gas feedstock.

3. The graphene cartridge filtration for hydrogen production of claim 1, wherein said gas input feedstock, graphene material, input gas port, returning purified hydrogen of 99.9% to the output port for delivery connections, or integrated into common processing equipment.

4. The hydrogen graphene cartridge filter system of claim 1, wherein said output of the graphene filtration allows only hydrogen gas of atomic size 1 to 2 Angstroms to pass from an impure or contaminated gas input feedstock is made safe and usable for fuel cells, automotive, industrial, and commercial applications.
